(19) United States
(12) Patent Application Publication
(10) Pub. No.: US 2016/0084206 A1
(43) Pub. Date: Mar. 24, 2016

(54) DIESEL ENGINE AND METHOD OF CONTROLLING SAME

(71) Applicant: ISUZU MOTORS LIMITED, Tokyo (JP)

(72) Inventor: Kunio NODA, Fujisawa (JP)

(73) Assignee: ISUZU MOTORS LIMITED, Tokyo (JP)

(21) Appl. No.: 14/891,045

(22) PCT Filed: May 21, 2014
(86) PCT No.: PCT/JP2014/063463

§ 371 Date: Nov. 13, 2015

(30) Foreign Application Priority Data
Jun. 27, 2013 (JP) 2013-134851

(51) Int. Cl. F02M 25/07; F02D 41/00

(52) U.S. Cl. CPC F02M 25/0754; F02M 25/0706; F02D 41/005; F02D 41/0057; F02M 2025/0759; F02M 2025/0763

(57) ABSTRACT

An exhaust gas recirculation controller that, closes an exhaust gas recirculation valve to stop exhaust gas recirculation, when an engine is accelerating, and when an increased amount of a fuel injection amount detected by a fuel injection detector is larger than a preset first threshold value, a boost pressure detected by a boost pressure detector is lower than a preset second threshold value, and an engine operation state detected by an engine operation state detector is outside a preset high rotation and high load operation state region. An exhaust gas amount flowing into a turbocharger can be confined within a proper range when accelerating a diesel engine, which avoids a rotational speed of the turbocharger from exceeding an allowable rotational speed.

### TECHNICAL FIELD

The present invention relates to a diesel engine and a method of controlling the same that can avoid unnecessary rise of a rotational speed of a turbocharger at the time of accelerating the engine, and can prevent trouble of the turbocharger, in the diesel engine comprising a turbocharging system and an EGR system.

### BACKGROUND ART

From a viewpoint of conservation of global environment, exhaust gas regulation of automobiles is progressing further. Particularly, reduction of particulate matter (PM) and nitrogen oxides (NOx) is required in a diesel engine mounted on a vehicle, and in the NOx reduction, EGR (exhaust gas recirculation) is performed that reduces a generation amount of NOx by recirculating into a cylinder a part of exhaust gas discharged from the cylinder, and lowering a combustion temperature in the cylinder.

In addition, in the diesel engine, a turbocharger is comprised, and turbocharging is performed in which a turbine provided in an exhaust passage is driven by energy of exhaust gas, an intake air is compressed by a compressor coupled to the turbine and provided in an intake passage, an air amount sent into the cylinder is increased, and in which combustion efficiency is improved.

As for a relation between the turbocharging and the EGR, for example, as is described in Japanese patent application Kokai publication No. 2007-85258, a supercharging pressure control device of an internal combustion engine in a gasoline engine of an internal EGR system has been proposed, in which: at the time of turbocharging, EGR is performed or an EGR amount is more increased as compared with a time when an EGR amount at the time of supercharging is not supercharged; thereby a part of energy of a current cycle in a cylinder is used in next and subsequent cycles; a total amount of energy, and energy of exhaust gas are increased in the next and subsequent cycles to increase a rotational speed of a turbocharger; thereby a supercharging pressure is raised more promptly; and hereby enhancing responsiveness of the supercharging pressure rise in the turbocharger to suppress deterioration of drivability.

Meanwhile, in the diesel engine, when a fuel injection amount into the cylinder is increased to accelerate the engine, control is performed in which: in order to improve engine acceleration performance, an EGR valve is closed, a part of exhaust gas discharged from the cylinder is made not to flow into an EGR passage, and all the exhaust gas discharged from the cylinder is made to flow into the turbocharger; thereby an exhaust gas flow rate to the turbocharger is increased to assist rise of the rotational speed of the turbocharger; thereby rise of a boost pressure is promoted to increase a supply amount of a fresh air into the cylinder and improve the engine acceleration performance.

However, in this control, since determination of whether to close the EGR valve is performed only by whether or not the engine is in an acceleration state, i.e., only by whether or not the fuel injection amount is rapidly increased, control is performed in which the EGR valve is closed regardless of the rotational speed of the turbocharger, so that the rotational speed is further raised.

Therefore, when the fuel injection amount is increased, and the EGR valve is closed, in accordance with a request for engine acceleration, in a state where the rotational speed of the turbocharger is already high in accelerating the engine, there arises a problem that an exhaust gas amount flowing into the turbocharger is rapidly increased, the rotational speed of the turbocharger rapidly rises exceeding an allowable rotational speed, and the turbocharger breaks down.

### PRIOR ART DOCUMENT

### Patent Documents

Patent Document 1: Japanese patent application Kokai publication No. 2007-85258

### SUMMARY OF THE INVENTION

### Problem to be Solved by the Invention

The present invention has been made in view of the above-described circumstances, and an object thereof is to provide a diesel engine and a method of controlling the same that can confine an exhaust gas amount flowing into a turbocharger within a proper range in accelerating the engine, hereby, can avoid a rotational speed of the turbocharger from rising exceeding an allowable rotational speed in accelerating the engine, and can prevent trouble of the turbocharger, in the diesel engine comprising a turbocharging system and an EGR system.

### Means for Solving the Problems

A diesel engine of the present invention for achieving the above-described object is the diesel engine comprising a turbocharging system and an EGR system, characterized in that the diesel engine has: a fuel injection amount detection unit; a boost pressure detection unit; an engine operation state detection unit; and an EGR control unit, and that the EGR control unit, in accelerating the engine, closes an EGR valve to stop EGR, in a case where an increased amount of a fuel injection amount detected by the fuel injection detection unit is larger than a preset first threshold value, a boost pressure detected by the boost pressure detection unit is lower than a preset second threshold value, and an engine operation state detected by the engine operation state detection unit is outside a preset high rotation and high load operation state region.

According to this configuration, in the acceleration of the engine, while an operation state of a turbocharger is determined based on not only the increased amount of the fuel injection amount but also the determination of the boost pressure and the engine operation state, whether EGR is performed or stopped is determined, and the EGR is stopped when the rotational speed of the turbocharger may be not less than the allowable rotational speed. Therefore, in the acceleration of the engine, an exhaust gas amount flowing into the turbocharger can be confined within a proper range, and hereby, the rotational speed of the turbocharger can be avoided from rising exceeding the allowable rotational speed in the acceleration of the engine, and trouble of the turbocharger can be prevented.

In the above-described diesel engine, when the second threshold value is set based on an engine speed and the fuel injection amount in the EGR control unit, determination of whether or not the rotational speed of the turbocharger may be not less than the allowable rotational speed can be made more accurately in the current acceleration of the engine, EGR can be performed almost to the limit where the rotational speed of the turbocharger does not exceed the allowable rotational speed, and fuel consumption can be improved, while suppressing a generation amount of NOx in exhaust gas.

Additionally, a method of controlling a diesel engine for achieving the above-described object is the method of controlling the diesel engine comprising a turbocharging system and an EGR system, characterized in that the method includes the step of, in accelerating the engine, closing an EGR valve to stop EGR, in a case where an increased amount of a fuel injection amount is larger than a preset first threshold value, a boost pressure is lower than a preset second threshold value, and an engine operation state is outside a preset high rotation and high load operation state region.

According to this method, since whether EGR is performed or stopped is determined, while observing not only the change of the fuel injection amount but the boost pressure and the engine operation state, EGR can be stopped when the rotational speed of the turbocharger may be not less than the allowable rotational speed. As a result of this, in the acceleration of the engine, since the exhaust gas amount flowing into the turbocharger can be confined within the proper range, the rotational speed of the turbocharger is avoided from rising exceeding the allowable rotational speed and trouble of the turbocharger can be prevented.

Note that although the first threshold value and the second threshold value, and the high rotation and high load operation state region in this case change with specifications of the diesel engine and specifications of the turbocharger, can be set by a result of a previously conducted experiment, etc., and are related to the engine speed, the fuel injection amount, etc., they can be set in forms, such as a numerical value, a function value, and map data.

### Effect of the Invention

According to the diesel engine and the method of controlling the same according to the present invention, in the diesel engine equpping the turbocharging system and the EGR system, in the acceleration of the engine, whether EGR is performed or stopped is determined, while observing not only the change of the fuel injection amount but the boost pressure and the engine operation state, thus, the exhaust gas amount flowing into the turbocharger can be confined within the proper range, hereby, the rotational speed of the turbocharger is avoided from rising exceeding the allowable rotational speed in the acceleration of the engine, and trouble of the turbocharger can be prevented.

### BRIEF DESCRIPTION OF THE DRAWINGS

FIG. 1 is a diagram schematically showing a configuration of a diesel engine including a turbocharging system and an EGR system of an embodiment of the present invention.

FIG. 2 is a flowchart showing one example of a control flow of a method of controlling the diesel engine of the embodiment of the present invention.

FIG. 3 is a diagram showing a configuration of a control device of the diesel engine of the embodiment of the present invention.

FIG. 4 is a graph schematically showing regions Ra and Rb in which an EGR valve is not closed and a region Rc in which the EGR valve is closed in acceleration of the engine, in the method of controlling the diesel engine of the embodiment of the present invention.

### MODES FOR CARRYING OUT THE INVENTION

Hereinafter, a diesel engine and a method of controlling the same of an embodiment according to the present invention will be explained with reference to drawings. Here, although the diesel engine is exemplified that has an EGR system in which a part of an EGR passage is provided in a cylinder head, the present invention is not limited to this, and the system may be an external EGR system or may be an internal EGR system.

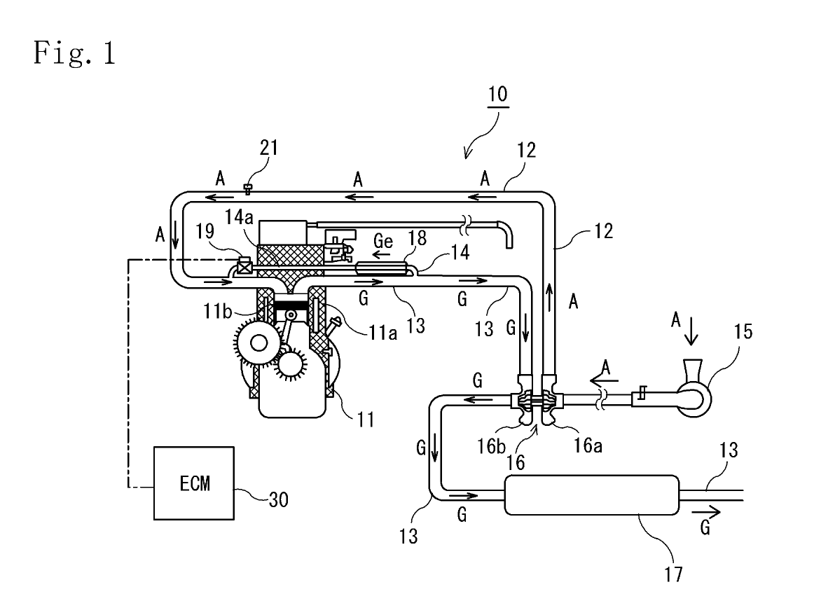

As shown in FIG. 1, a diesel engine 10 of the embodiment according to the present invention is configured to have an engine body 11, an intake passage 12, an exhaust passage 13 and an EGR passage 14. A plurality of cylinders 11a, pistons 11b, etc. are provided with the engine body 11, and an air cleaner 15, an intake amount sensor that is not shown, and a compressor 16a of a turbocharger 16 are provided in the intake passage 12 in order from an upstream side.

In addition, a turbine 16b of the turbocharger 16, and an exhaust gas purification device 17 are provided in the exhaust passage 13 in order from the upstream side. The EGR passage 14 branches from the exhaust passage 13 between the engine body 11 and the turbine 16b, and joins the intake passage 12 between the compressor 16a and the engine body 11 through an EGR cooler 18, an internal EGR passage 14a provided inside a cylinder head 11c, and an EGR valve 19.

The exhaust gas purification device 17 is a post-treatment device for purifying PM (particulate matter) and NOx (nitrogen oxides) in exhaust gas G discharged from the engine body 11, and composes a combination of some exhaust gas purification units, such as a pre-stage oxidation catalyst device, a PM capturing filter device, an NOx occlusion reduction type catalyst device, a urea supply nozzle, and a urea SCR device.

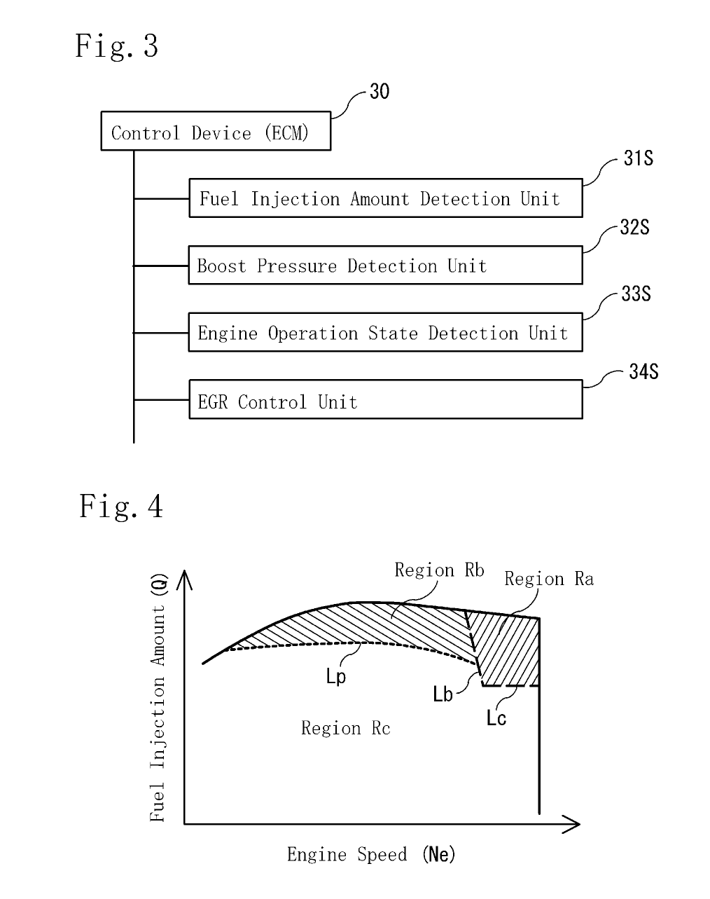

In addition, a control device (an ECM: an engine control module) 30 that controls the whole operation of the diesel engine 10 is provided, and as shown in FIG. 3, the control device 30 is configured to have a fuel injection amount detection unit 31S, a boost pressure detection unit 32S, an engine operation state detection unit 33S and an EGR control unit 34S.

Additionally, the EGR control unit 34S is configured to close the EGR valve 19 to thereby stop EGR, when in acceleration of the engine, an increased amount ΔQ of a fuel injection amount Q detected by the fuel injection detection unit 31S is larger than a preset first threshold value ΔQc, and when the boost pressure detection unit 32S has a boost pressure sensor 21 arranged in the intake passage 12 and a boost pressure Pb detected by the boost pressure sensor 21 is lower than a preset second threshold value Pbc, and when the engine operation state detection unit 33S inputs values of an engine speed Ne and the fuel injection amount Q and an engine operation state detected with reference to map data etc. indicating an engine operation region by the engine speed Ne and the fuel injection amount Q is outside a preset high rotation and high load operation state region Ra.

Note that since the first threshold value ΔQc and the second threshold value Pbc, and the high rotation and high load operation state region in this case change with specifications of the diesel engine 10 and specifications of the turbocharger 16, they are values preset by an experiment etc.

The first threshold value ΔQc is the threshold value for determining whether an engine acceleration state is sudden acceleration or slow acceleration. In addition, the second threshold value Pbc is the value for determining whether a current rotational speed Nt of the turbocharger 16 is high or low by the boost pressure Pb, the second threshold value Pbc is preferably set based on the engine speed Ne and the fuel injection amount Q, i.e., is preferably set to be a value serving as a function of the engine speed Ne and the fuel injection amount Q. And the second threshold value Pbc is the value that can already be set at the time of control by referring to map data etc. preset by an experiment etc. by the engine speed Ne and the fuel injection amount Q at the time of engine operation. In FIG. 4, the second threshold value Pbc is shown by a line Lp between a region Rb and a region Rc.

In addition, the high rotation and high load operation state region (it is shown as the region Ra in FIG. 4) is also the value for determining whether the rotational speed Nt of the turbocharger 16 is high or low, the region is preferably set based on the engine speed Ne and the fuel injection amount Q, i.e., is preferably set to be a value serving as a function of the engine speed Ne and the fuel injection amount Q. And the region is a range that can be set at the time of control by referring to map data etc. preset by the experiment etc. by the engine speed Ne and the fuel injection amount Q at the time of engine operation. In FIG. 4, boundaries of the high rotation and high load operation state region Ra are shown by a line Lb and a line Lc.

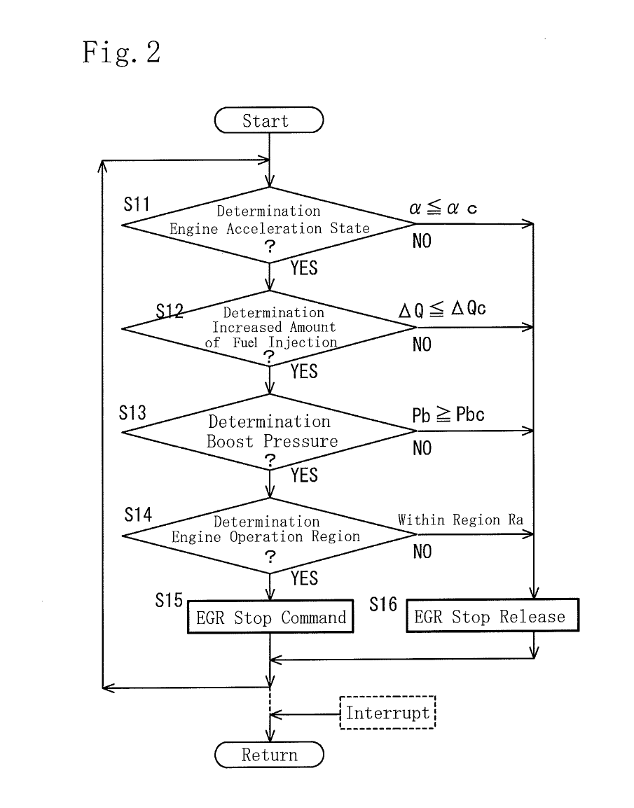

A method of controlling the diesel engine will be explained with reference to a control flow of FIG. 2. The control flow of FIG. 2 is shown as the following control flow. The control flow is repeatedly called by an upper control flow which starts with the operation start of the diesel engine 10, then starts. Then the control flow is executed. Along with the operation stop of the diesel engine 10, the control flow is interrupted and processing returns to the upper control flow. The control flow is stopped along with the stop of the upper control flow.

When the control flow of FIG. 2 is called by the upper control flow and started, it is determined in step S11 whether or not the diesel engine 10 is in an acceleration state. In a case of the diesel engine 10 mounted on a vehicle, the determination is made by whether or not an accelerator opening angle α operated by a driver is larger than a preset accelerator opening angle threshold value αc. If in the determination in step S11, the accelerator opening angle α is larger than the accelerator opening angle threshold value αc, and the diesel engine 10 is in the engine acceleration state (YES), processing proceeds to determination of an increased amount of a fuel injection amount of next step S12, and if the accelerator opening angle α is not more than the accelerator opening angle threshold value αc, and the diesel engine 10 is not in the engine acceleration state (NO), processing proceeds to EGR stop release of step S16.

In step S12, it is determined whether or not the increased amount ΔQ of the fuel injection amount Q is larger than the first threshold value ΔQc, and if it is larger (YES), processing proceeds to determination of a boost pressure of step S13, and if the increased amount ΔQ of the fuel injection amount Q is not more than the first threshold value ΔQc (NO), processing proceeds to the EGR stop release of step S16.

In step S13, it is determined whether or not the boost pressure Pb is larger than the second threshold value Pbc with reference to map data from the current engine speed Ne and the fuel injection amount Q, and if it is smaller (YES), processing proceeds to determination of an engine operation region of step S14, and if the boost pressure Pb is not less than the second threshold value Pbc (NO), processing proceeds to the EGR stop release of step S16.

In step S14, it is determined whether or not the engine operation region is outside the high rotation and high load operation region Ra with reference to map data from the current engine speed Ne and the fuel injection amount Q, and if it is outside the high rotation and high load operation region Ra (YES), processing proceeds to EGR stop of step S15, and if it is inside the high rotation and high load operation region Ra (NO), processing proceeds to the EGR stop release of step S16.

In step S15, the EGR valve 19 is closed to stop EGR. In this case, even though currently, EGR control is performed by other control, and a valve opening of the EGR valve 19 is controlled, the control of step S15 takes priority, the EGR valve 19 is closed, and a part Ge of the exhaust gas G is prevented from flowing into the EGR passage 14. Processing then returns to step S11.

Meanwhile, in step S16, in a state where the EGR valve 19 is closed, and where EGR is stopped, in this control, the EGR valve 19 is opened, and the state where EGR is stopped is released. Processing then returns to step S11.

The control of EGR when the EGR stop is released, i.e., control of the valve opening of the EGR valve 19, is performed by EGR control other than the control by the control flow of FIG. 2 and, for example, the control is set based on preset EGR map data etc. based on the engine speed Ne and the fuel injection amount Q. This control is the same as control performed based on a conventional well-known technology.

In the control flow of FIG. 2, steps S11 to S15 or steps S11 to S16 are repeatedly carried out, and an interrupt is generated along with the operation stop of the diesel engine 10, the control flow is interrupted, processing proceeds to a return and returns to the upper control flow, and the control flow is stopped along with the stop of the upper control flow.

By this control, in the method of controlling the diesel engine including the turbocharging system and the EGR system, when in acceleration of the engine, the increased amount ΔQ of the fuel injection amount Q is larger than the preset first threshold value ΔQc, the boost pressure Pb is lower than the preset second threshold value Pbc, and the engine operation state is outside the preset high rotation and high load operation state region Ra, the EGR valve 19 can be closed to stop EGR.

Additionally, according to the diesel engine 10 configured as described above and the method of controlling the same, in the diesel engine 10 including the turbocharging system and the EGR system, in acceleration of the engine, whether EGR is performed or stopped is determined, while observing not only the change of the fuel injection amount Q but the boost pressure Pb and the engine operation state, thus an exhaust gas amount flowing into the turbocharger 16 can be confined within a proper range, hereby, the rotational speed Nt of the turbocharger 16 is avoided from rising exceeding an allowable rotational speed Nta in the acceleration of the engine, and trouble of the turbocharger 16 can be prevented.

### INDUSTRIAL APPLICABILITY

According to the diesel engine and the method of controlling the same according to the present invention, in the diesel engine including the turbocharging system and the EGR system, the rotational speed of the turbocharger is avoided from rising exceeding the allowable rotational speed in acceleration of the engine, trouble of the turbocharger can be prevented, and thus, the present invention can be utilized as a diesel engine mounted on an automobile etc. and a method of controlling the same.

### EXPLANATION OF REFERENCE NUMERALS

10 DIESEL ENGINE

11 ENGINE BODY

11a CYLINDER

11b PISTON

12 INTAKE PASSAGE

13 EXHAUST PASSAGE

14 EGR PASSAGE

14c INTERNAL EGR PASSAGE

15 AIR CLEANER

16 TURBOCHARGER

16a COMPRESSOR

16b TURBINE

17 EXHAUST GAS PURIFICATION DEVICE

18 EGR COOLER

19 EGR VALVE

21 BOOST PRESSURE SENSOR

30 CONTROL DEVICE (ECM)

31S FUEL INJECTION AMOUNT DETECTION UNIT

32S BOOST PRESSURE DETECTION UNIT

33S ENGINE OPERATION STATE DETECTION UNIT

34S EGR CONTROL UNIT

Ra HIGH ROTATION AND HIGH LOAD OPERATION STATE REGION

Rb REGION (Pb≧Pbc, AND OUTSIDE REGION Ra)

Rc REGION (Pb<Pbc, AND OUTSIDE REGION Ra)

Lp BOUNDARY (Pbc) OF REGION Rb and REGION Rc

Lb and Lc BOUNDARIES OF “REGION Ra and REGION Rb” AND REGION Rc

Nt ROTATIONAL SPEED OF TURBOCHARGER

Nta ALLOWABLE ROTATIONAL SPEED OF TURBOCHARGER

Ne ENGINE SPEED

Pb BOOST PRESSURE

Pbc SECOND THRESHOLD VALUE

Q FUEL INJECTION AMOUNT

ΔQ INCREASED AMOUNT OF FUEL INJECTION AMOUNT

ΔQc FIRST THRESHOLD VALUE

α ACCELERATOR OPENING ANGLE

αc ACCELERATOR OPENING ANGLE THRESHOLD VALUE

1. A diesel engine, comprising:
a fuel injection amount detector;
a boost pressure detector;
an engine operation state detector; and an exhaustion gas recirculation controller,
wherein the exhaustion gas recirculation controller closes an exhaustion gas recirculation valve to stop EGR, when the engine is accelerating, and when an increased amount of a fuel injection amount detected by the fuel injection detector is larger than a preset first threshold value, a boost pressure detected by the boost pressure detector is lower than a preset second threshold value, and an engine operation state detected by the engine operation state detector is outside a preset high rotation and high load operation state region.

2. The diesel engine according to claim 1, wherein the second threshold value is set based on an engine speed and the fuel injection amount.

3. A method of controlling a diesel engine, comprising:
accelerating the engine;
detecting a fuel injection amount;
comparing the detected increased fuel injected amount with a preset limit threshold value;
measuring a boost pressure;
comparing the measured boost pressure with a preset second threshold value;
detecting an engine operation state;
comparing the detected engine operation state with a preset high rotation and high load operation state region; and
closing an exhaustion gas recirculation valve to stop exhaustion gas recirculation when the detected fuel injection amount is larger than the preset first threshold value, the detested boost pressure is lower than the preset second threshold value, and the detested engine operation state is outside the preset high rotation and high load operation state region.
